(19) United States
(12) Patent Application Publication
(10) Pub. No.: US 2014/0184095 A1
(43) Pub. Date: Jul. 3, 2014

(54) DC Power-Supply Apparatus

(71) Applicant: SANKEN ELECTRIC CO., LTD., Niiza-shi (JP)

(72) Inventors: Mitsutomo Yoshinaga, Niiza-shi (JP); Kengo Kimura, Niiza-shi (JP); Toshihiro Nakano, Niiza-shi (JP)

(73) Assignee: SANKEN ELECTRIC CO., LTD., Niiza-shi (JP)

(21) Appl. No.: 14/141,468

(22) Filed: Dec. 27, 2013

(30) Foreign Application Priority Data
Dec. 28, 2012 (JP) 2012-287399

(51) Int. Cl. H02M 7/06; H05B 37/02

(52) U.S. Cl. CPC H02M 7/06; H05B 37/02
USPC 315/291; 363/126

(57) ABSTRACT

A DC power-supply apparatus of converting an AC input voltage rectified to a DC voltage and supplying it to a load, by performing on-and-off control of a switching element connected in series to a reactor, includes a control circuit, which operates in floating state with respect to a after-rectified ground line and controls an on-width of the switching element based on a value of current flowing through the reactor and the load connected in series with the reactor; and an oscillation circuit, which controls a switching frequency of the on-and-off control by the control circuit, asynchronously with energy release timing of the reactor.

### CROSS-REFERENCE TO RELATED APPLICATION

This application claims priority from Japanese Patent Application No. 2012-287399 filed on Dec. 28, 2012, the entire subject matter of which is incorporated herein by reference.

### TECHNICAL FIELD

This disclosure relates to a DC power-supply apparatus that converts an AC input voltage from a commercial AC power source to a desired DC voltage and output it.

### BACKGROUND

In a DC power-supply apparatus of an LED lighting device or the like for use in a commercial power source, there is a model supporting a world wide input, which automatically corresponds to a voltage of the commercial power source used in each country, and an AC input voltage to be inputted fluctuates greatly by AC120V to 400V or so. In the case where a step-down chopper of a non-isolated type is used in an LED lighting device or the like, in view of achieving a high-density mounting with narrowing an insulation distance on the safety standard by suppressing the maximum value of a voltage waveform of a switching element or in view of significantly exceeding a Vcc-GND breakdown voltage of a control circuit unit configured by control ICs, a floating down chopper is used. In the floating down chopper, a GND terminal of the control circuit unit is floated and is not connected to an after-rectified GND potential (for example, see JP-A-2012-16138.)

JP-A-2012-16138 discloses to perform an average-current-value controlling in a critical mode. When the average-current value control which also serves as a power-factor correction operation is performed in the critical mode, oscillation frequency varies from a 0 voltage to a peak voltage in the AC input voltage. Each of switching currents at the oscillation frequency is smoothed by a filter circuit of a rectifying-and-smoothing unit, and it is to be an output current waveform.

As shown in FIG. 21, in the background LED lighting device 1 operating in the critical mode, a commercial AC power source AC is connected to an AC input terminal of a rectifier circuit DB via an AC line filter (EMI filter), the control circuit unit Z1 having a COMMON terminal as being in a floated state is connected to a positive terminal of a rectification output (the positive terminal of the capacitor Cin) of the rectifier circuit DB. In the subsequent stage, circuit configuration components of the step-down chopper such as an inductor L1, a regeneration diode D1, a smoothing capacitor C1 are connected.

A switching element M1 such as a MOSFET is installed in the control circuit unit Z1. A terminal D/ST terminal, to which a drain of the switching element M1 is connected, is connected to the positive terminal of the rectification output (positive terminal of the capacitor Cin) of the rectifier circuit DB, and the COMMON terminal, to which a source of the switching element M1 is connected, is connected to one terminal of the current detection resistor R1. Further, the other terminal of the current detection resistor R1 is connected to one terminal of the reactor L1, the other terminal of the reactor L1 is a positive output terminal to which an LED load RL is connected. A negative output terminal, to which the LED load RL is connected, is connected to a negative terminal of the rectification output (negative terminal of the capacitor Cin) of the rectifier circuit DB, and a line connecting the negative output terminal and the negative terminal of the rectification output (negative terminal of the capacity Cin) of the rectifier circuit DB is a ground line GND1. The connection point between the COMMON terminal of the control circuit unit Z1 and the current detection resistor R1 is connected to a cathode terminal of the regeneration diode D1, and an anode terminal of the regeneration diode D1 is connected to the ground line GND1. Further, the smoothing capacitor C1 is connected between the connection point of the reactor L1 with the positive output terminal, to which the LED load RL is connected, and the ground line GND1.

A capacitor C2 is connected, via the diode D2, between the connection point between the reactor L1 and the positive output terminal to which the LED load

RL is connected and the connection point between the COMMON terminal of the control circuit unit Z1 and the current detection resistor R1, and the connection point between the diode D2 and the capacitor C2 is connected to the VCC terminal of the control circuit unit Z1. As a result, the power of the control circuit unit Z1 is supplied by the bootstrap configuration from the LED load RL.

Further, a capacitor C3 is connected, via the resistor R2, between the connection point of the current detection resistor R1 with the reactor L1 and the connection point of the COMMON terminal of the control circuit unit Z1 with the current detection resistor R1, and the connection point between the resistor R2 and the capacitor C3 is connected to the FB terminal of the control circuit unit Z1. The series circuit of the resistor R2 and the capacitor C3 functions as a filter. According to the current detection resistor R1, a current value flowing in the LED load RL and the reactor L1 is input to a FB pin of the control circuit unit Z1 as a negative voltage with respect to the COMMON terminal. Incidentally, a capacitor C4 is connected between a FBOUT terminal of the control circuit unit Z1 and the COMMON terminal. The capacitor C4 has a time constant longer than a half cycle of the AC input voltage Vin with respect to the value of inflow/outflow current from the FBOUT terminal, and a voltage appearing at the FBOUT terminal through the capacitor C4 is sufficiently smoothed to be, substantially, a DC level.

Further, the connection point between the reactor L1 and the positive output terminal connected to the LED load RL is connected to a BD terminal (bottom detector) of the control circuit unit Z1, via the diode D3 and resistor R3. Further, a capacitor C5 is connected, via a resistor R4, between the connection point of the reactor L1 with the current detection resistor R1 and the connection point of the current detection resistor R1 with the COMMON terminal of the control circuit unit Z1, and the connection point between the resistor R4 and the capacitor C5 is connected to an OCP terminal of the control circuit unit Z1.

As shown in FIG. 22, the control circuit unit Z1, in which the switching element M1 is installed, is provided with a transconductance amplifier OTA, comparators CP1, CP2, CP3, and CP4, a constant current circuit CC, a capacitor Ct, a switching element M2, and an AND circuit AND.

The transconductance amplifier OTA, in which the inverting input terminal is connected to the FB terminal, is configured to compare the negative voltage input to the FB terminal with the reference voltage connected to the non-inverting input terminal and to amplify the difference between the compared voltages, thereby converting from a voltage signal to a current signal and outputting the converted signal. The output terminal of the transconductance amplifier OTA is connected to the FBOUT terminal and the non-inverting input terminal of the comparator CP1. Thus, the output of the transconductance amplifier OTA is converted with a voltage signal, which has been sufficiently smoothed to substantially the DC level by the capacitor C4 connected to the FBOUT terminal, and then it is input as an FB voltage to the non-inverting input terminal of the comparator CP1.

The inverting input terminal of the comparator CP1 is connected to the output terminal of the constant current circuit CC, one terminal of the capacitor Ct and the drain of the switching element M2 from one another. Here, the constant current circuit CC, the capacitor Ct and the switching element M2 configure a triangular wave oscillator, and the triangular wave is inputted to the inverting input terminal of the comparator CP1. That is, in the state where the switch element M2 is turned off, the capacitor Ct is charged at a constant current by the constant current circuit CC, so that the slope of the triangular waveform is determined. The switching element M2 is turned on, so that the reset timing of the triangular wave oscillation is determined. The gate of the switching element M2 is connected to the output terminal of the comparator CP2, in which the non-inverting input terminal is connected to the BD terminal, and the switching element M2 is turned on at the energy release timing of the reactor L1. The output terminal of the comparator CP1 is connected to the gate of the switching element M1 via the AND circuit AND. Accordingly, an ON-width signal corresponding to the FB voltage is generated, and the switching operation of the switching element M1 is performed in the critical mode. According to the voltage mode control in which the ON-width is determined only by the FB voltage, the switching current flows as in proportional to the sine-wave voltage obtained by rectifying the input AC voltage, and at the same time it has also a power-factor correction function. Due to the operation in the critical mode, namely, since the switching element M1 is turned on at the lowest point of the voltage resonance period of the reactor L1, it is possible to realize low noise power.

The comparator CP3 is an OVP circuit (overvoltage protection circuit) for overvoltage detection. The inverting input terminal of the comparator CP3 is connected to the Vcc terminal, and the output terminal thereof is connected to an input terminal of the AND circuit AND. Therefore, when the Vcc terminal voltage exceeds a predetermined threshold during a load opening, the output of the comparator CP3 is turned off, so that the switching operation of the switching element M1 is stopped.

The comparator CP4 is an OCP circuit (overcurrent protection circuit) for overcurrent detection. The inverting input terminal of the comparator CP4 is connected to the OCP terminal, and the output terminal thereof is connected to an input terminal of the AND circuit AND. Therefore, when the current flowing through the current detection resistor R1 connected in series with the LED load RL exceeds a predetermined threshold, the output of the comparator CP4 is turned off, so that the switching operation of the switching element M1 is stopped.

### SUMMARY

In the LED lighting device, a harmonic current regulation, which determines how much a sine-wave is closer to the waveform of the input current Iin, is to be an important specification. However, in the background prior art, since the waveform of the input current Iin easily deviate from the sine-wave, there is a problem that the harmonic current regulation cannot be satisfied. That is, in the case where the power-factor correction circuit without a multiplier is operated in the critical mode, the off-time is shortened since the energy release amount of the reactor L1 is small at a low voltage of the AC input voltage Vin and the cycle thereof is relatively shortened even though the on-time is substantially constant regardless of the magnitude of the AC voltage. As a result, as shown in FIG. 23 the oscillation frequency (switching frequency of the switching element M1) of the triangular wave that is input to the inverting input terminal of the comparator CP1 has a characteristic such that the frequency is to be higher in the vicinity of 0 (V) of the AC input voltage Vin, and the average value of the switching current increases in the vicinity of the 0 (V). Therefore, as shown in FIG. 24A, since the waveform of the input current Iin is slightly deviated from the sine-wave. Even though the power factor may be sufficient, the current distortion (A THD) is large, and it becomes a current waveform rich in harmonics. Further, as shown in FIG. 24B, when a 50% dimming or the like of the LED load is performed, the current distortion is more increased. Further, due to the configuration of the AC line filter, a peak shape of switching current waveform is not to be the input current waveform.

This disclosure provide at least a DC power-supply apparatus which is capable of causing an input current waveform to be close to a sine-wave and easily achieving harmonic current regulation.

A DC power-supply apparatus of this disclosure, which converts an AC input voltage rectified to a DC voltage and supplies it to a load, by performing on-and-off control of a switching element connected in series to a reactor, includes: a control circuit, which operates in floating state with respect to a after-rectified ground line and controls an on-width of the switching element based on a value of current flowing through the reactor and the load connected in series with the reactor; and an oscillation circuit, which controls a switching frequency of the on-and-off control by the control circuit, asynchronously with energy release timing of the reactor.

In the above-described DC power-supply apparatus, the oscillation circuit may control the switching frequency to be constant.

In the above-described DC power-supply apparatus, the load may be an LED, and the control circuit may perform a constant current control so that values of current flowing in the reactor and the load are constant.

Meanwhile, a DC power-supply apparatus of this disclosure, which converts an AC input voltage rectified to a DC voltage and supplies it to a load, by performing on-and-off controlling of a switching element connected in series to a reactor, includes: a control circuit, which operates in floating state with respect to a after-rectified ground line and controls an on-width of the switching element based on a value, as a feedback signal, of current flowing through the reactor and the load connected in series with the reactor; a voltage rise detecting circuit, which detects an increase of an output voltage and performs pull-up or pull-down of the feedback signal; and an overvoltage protection circuit, which stops the on-and-off control of the switching element by the pull-up or pull-down of the feedback signal.

According to this disclosure, it is possible to perform a switching operation that is different from the critical mode and to cause an input current waveform to be close to a sine-wave and easily satisfy the harmonic current regulation.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a circuit diagram illustrating a circuit configuration of a DC power-supply apparatus according to a first illustrative embodiment of this disclosure;

FIG. 2 is a circuit diagram illustrating the circuit configuration of the control circuit shown in FIG. 1;

FIG. 3 is a waveform diagram illustrating a relationship between an AC input voltage and an oscillation frequency in a control circuit unit shown in FIG. 1;

FIGS. 4A and 4B are waveform diagrams illustrating the relationship between an input current and an AC input when an input power supply is AC 100V in the DC power-supply apparatus according to the first illustrative embodiment (FIG. 4A) and the background art (FIG. 4B);

FIGS. 5A and 5B are waveform diagrams illustrating the relationship between an input current and an AC input when an input power supply is at AC 230V in the DC power-supply apparatus according to the first illustrative embodiment (FIG. 5A) and the background art (FIG. 5B);

FIGS. 6A and 6B are waveform diagrams illustrating the relationship between an input current and an AC input when a 50% dimming is performed in the case where an input power supply is at AC 100V in the DC power-supply apparatus according to the first illustrative embodiment (FIG. 6A) and the background art (FIG. 6B);

FIGS. 7A and 7B are waveform diagrams illustrating the relationship between an input current and an AC input when a 50% dimming is performed in the case where an input power supply is AC 230V in the DC power-supply apparatus according to the first illustrative embodiment (FIG. 7A) and the background art (FIG. 7B);

FIG. 8 is a circuit diagram illustrating a circuit configuration of the DC power-supply apparatus according to a second illustrative embodiment of this disclosure;

FIG. 9 is a circuit diagram illustrating a circuit configuration of the control circuit unit shown in FIG. 8;

FIG. 10 illustrates waveform diagrams (a) to (e) of each part of the control circuit unit shown in FIG. 8;

FIG. 11 illustrates a waveform diagram illustrating the relationship between an AC input voltage and an oscillation frequency in the control circuit unit shown in FIG. 8;

FIG. 12 is a circuit diagram illustrating a circuit configuration of the DC power-supply apparatus according to a third illustrative embodiment of this disclosure;

FIG. 13 is a circuit diagram illustrating a circuit configuration of the DC power-supply apparatus according to a fourth illustrative embodiment of this disclosure;

FIG. 14 is a circuit diagram illustrating a circuit configuration that is applied to a buck-boost circuit in the DC power-supply apparatus according to the first illustrative embodiment of this disclosure;

FIG. 15 is a circuit diagram illustrating a circuit configuration that is applied to a buck-boost circuit in the DC power-supply apparatus according to the second illustrative embodiment of this disclosure;

FIG. 16 is a circuit diagram illustrating a circuit configuration that is applied to a buck-boost circuit in the DC power-supply apparatus according to the first illustrative embodiment of this disclosure;

FIG. 17 is a circuit diagram illustrating a circuit configuration that is applied to a buck-boost circuit in the DC power-supply apparatus according to the first illustrative embodiment of this disclosure;

FIG. 18 is a circuit diagram illustrating flow of a leakage current at the lights-out time in a buck chopper circuit;

FIG. 19 is a circuit diagram illustrating flow of a leakage current at the lights-out time in a buck chopper circuit;

FIG. 20 is a circuit diagram illustrating flow of a leakage current at the lights-out time in a buck chopper circuit;

FIG. 21 is a circuit diagram illustrating a circuit configuration of a DC power-supply apparatus according to a background art;

FIG. 22 is a circuit diagram illustrating a circuit configuration of a control circuit unit shown in FIG. 21;

FIG. 23 is a waveform diagram illustrating the relationship between an AC input voltage and an oscillation frequency in the control circuit unit shown in FIG. 21; and

FIGS. 24A and 24B are waveform diagrams illustrating the relationship between an input current and an AC input voltage in the case where the input power supply is at AC 100V (FIG. 24A) and a 50% dimming at AC 100V is performed (FIG. 24B) in the DC power-supply apparatus according to the background art.

### DETAILED DESCRIPTION

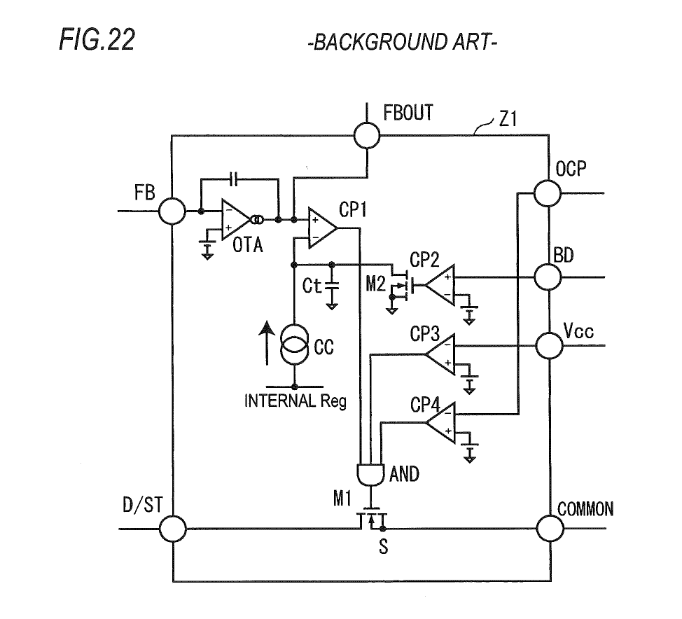

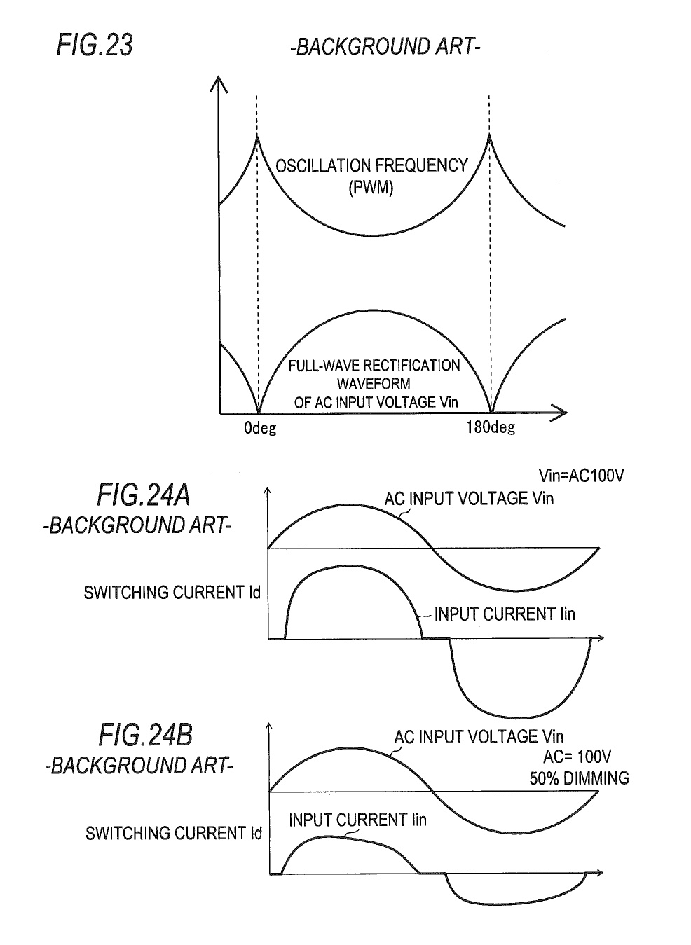

Hereinafter, illustrative embodiments of this disclosure will be described in detail with reference to the drawings. Here, the similar components as the background circuit described in FIG. 21 and FIG. 22 are referred to as the same reference numerals and descriptions thereof will be omitted.

### First Illustrative Embodiment 1

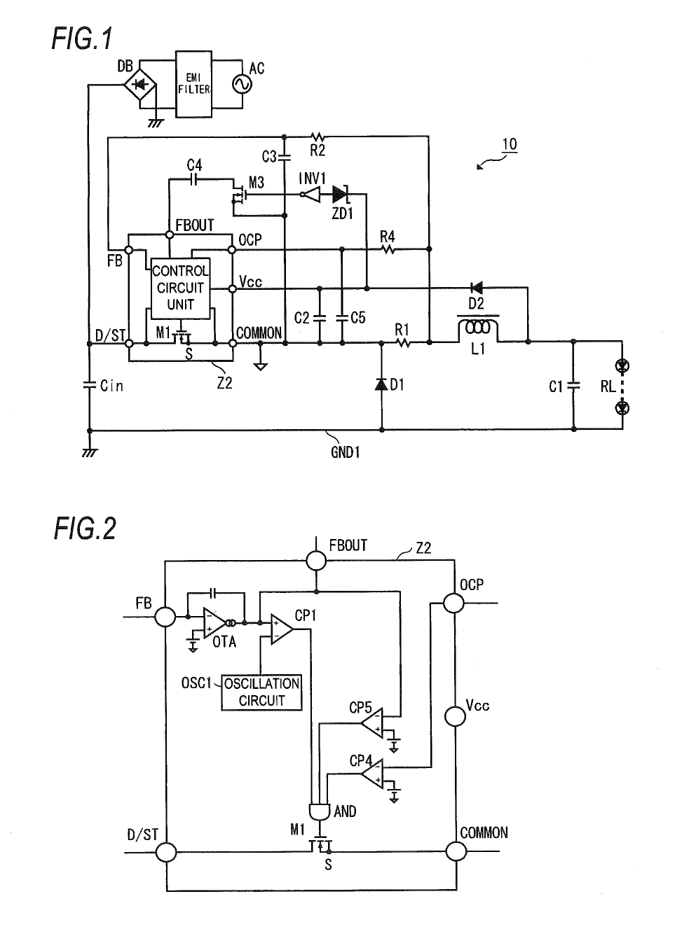

As shown in FIG. 1, in the LED lighting device 10 of the DC power-supply apparatus according to the first illustrative embodiment of this disclosure, the control circuit unit Z2 having the COMMON terminal being in the floated state is connected to the positive terminal of the rectification output (the positive terminal of the capacitor Cin) of the rectifier circuit DB. The control circuit unit Z2 has a configuration in which the BD (bottom detect) terminal is not provided and in which energy release timing of the reactor L1 is not to be input.

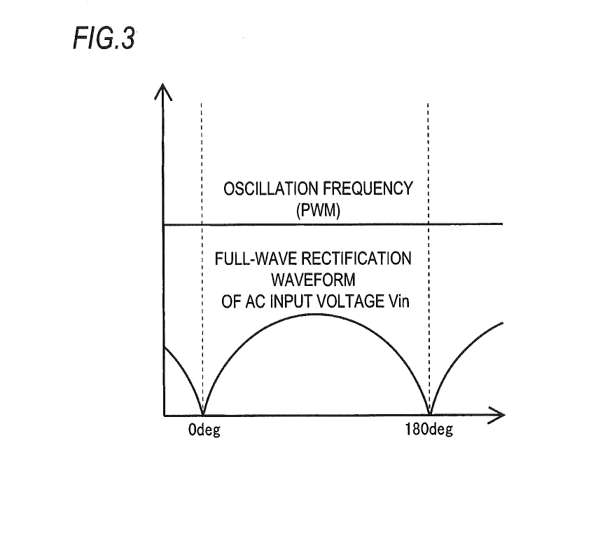

As shown in FIG. 2, in the control circuit unit Z2, the inverting input terminal of the comparator CP1 is connected to the output terminal of the oscillator OSC1. The oscillation circuit OSC1 is an oscillation circuit which outputs a triangle wave that is asynchronous with the energy release timing of the reactor L1. In the first illustrative embodiment, the oscillator circuit OSC1 outputs a triangular wave in a constant cycle that is set in advance, and as shown in FIG. 3, the oscillation frequency is constant regardless of the zero peak of the AC input voltage Vin. Therefore, the output of the comparator CP1 becomes a PWM signal, in which the period thereof is constant and the duty cycle of the ON-width is changed in response to the feedback voltage input to the non-inverting input terminal.

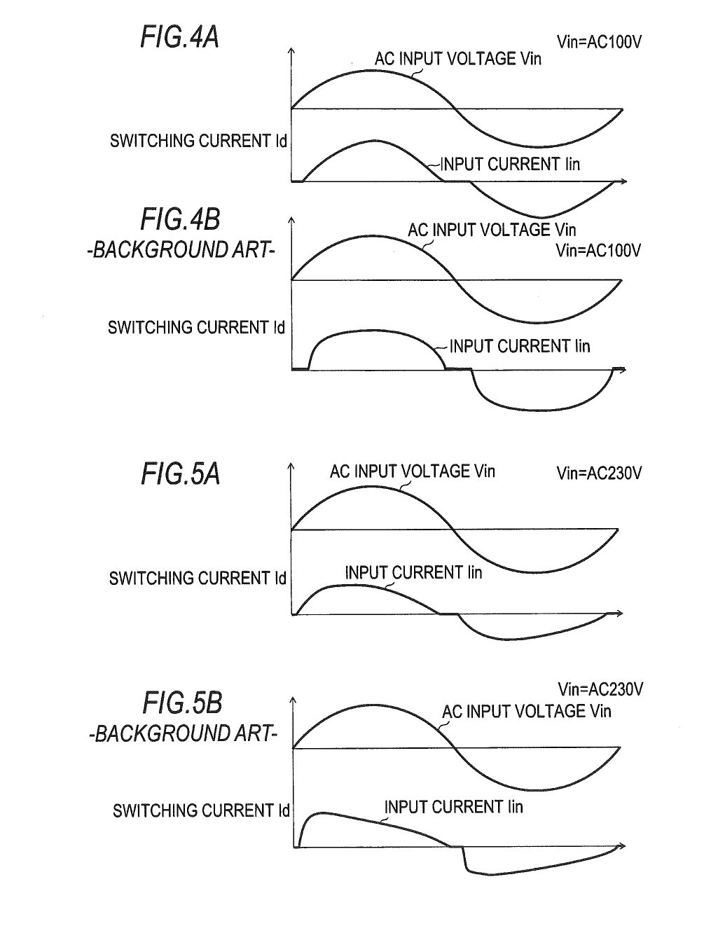

FIG. 4A illustrates the relationship between the AC input voltage Vin and input current Iin in the LED lighting device 10 in the case of where the AC input voltage Vin is AC 100V. As shown in FIGS. 4A and 4B, the input current Iin in the LED lighting device 10 shown in FIG. 4A is in a shape closer to a sine-wave, as compared to the input current Iin in the LED lighting device 1 of the background art. Thus, in the LED lighting apparatus 10, the current distortion (A THD) decreases as compared with the background circuit (LED lighting device 1), and thereby it is possible to suppress the harmonic current.

FIG. 5A illustrates the relationship between the input current Iin and the AC input voltage in the LED lighting device 10 in the case where the AC input voltage is AC 230V, and FIG. 5B illustrates the relationship between the input current Iin and the AC input voltage Vin in the background circuit (LED lighting device 1) in the case where the AC input voltage Vin is AC230V.

As shown in FIGS. 5A and B, it can be seen that the LED lighting device 10 and the background circuit (LED lighting device 1) are different greatly from each other in the waveform of the input current Iin. The waveform of the input current Iin in the LED lighting device 10 is closer to a sine-wave, thereby it has advantageous to the harmonic measure.

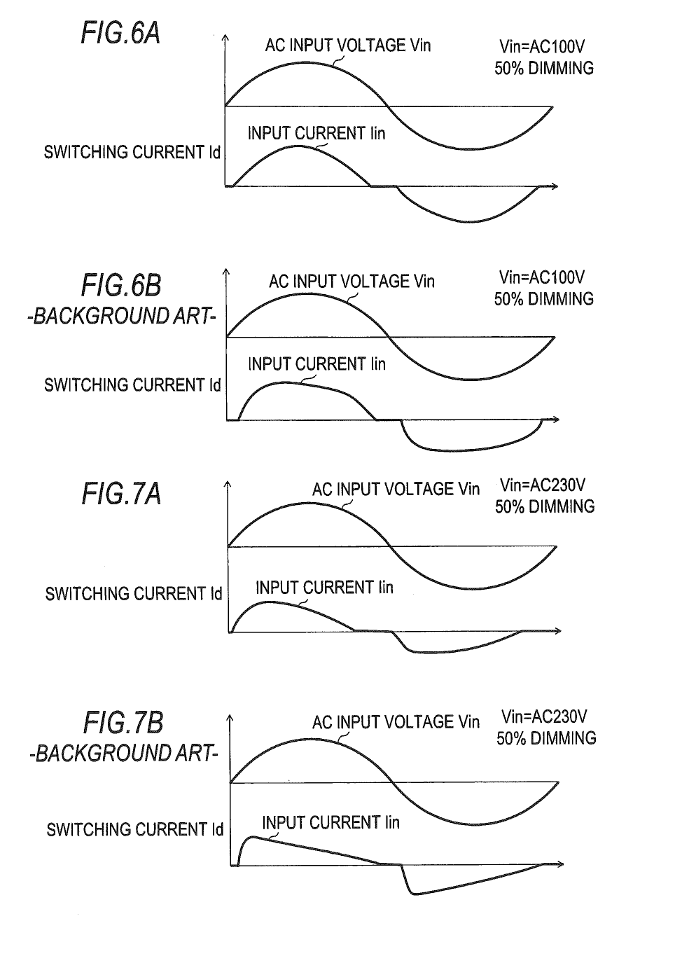

FIG. 6A illustrates the relationship between the AC input voltage Vin and input current Iin in the LED lighting device 10 in case of 50% dimming at AC100V of the AC input voltage Vin, and FIG. 6B illustrates the relationship between the AC input voltage Vin and the input current Iin in the background circuit (LED lighting device 1) in case of the 50% dimming at AC100V of the AC input voltage Vin.

Further, FIG. 7A illustrates the relationship between the AC input voltage Vin and the input current Iin in the LED lighting device 10 in case of the 50% dimming at AC 230V of the AC input voltage Vin, and FIG. 7B illustrates the relationship between the AC input voltage Vin and the input current Iin in the background circuit (LED lighting device 1) in case of the 50% dimming at AC230V of the input voltage Vin. As shown in FIGS. 6A and 6B and FIGS. 7A and 7B, the background circuit (LED lighting device 1) and the LED lighting device 10 are different greatly from each other in the waveform of the input current Iin. and even at the time of the dimming (light load), the waveform of the input current Iin in the LED lighting device 10 is closer to a sine-wave, thereby it has advantageous to the harmonic measures.

Further, as shown in FIG. 1, the LED lighting device 10 is provided with the switching element M3 such as a small-signal MOSFET or the like connected between the COMMON terminal and the capacitor C4 connected to the FBOUT terminal of the control circuit unit Z2, and the Zener diode ZD1 and the inverting circuit INV1 connected between the gate of the switching device M3 and the Vcc terminal of the control circuit unit Z2. The Vcc terminal of the control circuit unit Z2 and the cathode of the Zener diode ZD1 are connected to each other, and the anode of the Zener diode ZD1 is connected to the gate of the switching element M3 through the inverting circuit INV1. As shown in FIG. 2, the control circuit unit Z2 is provided with the comparator CP5 functioning as an OVP circuit (overvoltage protection) for overvoltage detection when a load is open. The inverting input terminal of the comparator CP5 is coupled to the FBOUT terminal, and the output terminal thereof is connected to the input terminal of the AND circuit AND.

The switching element M3 is in an on-state in a normal time (in case where a voltage of the Vcc terminal is below the Zener voltage of the Zener diode ZD1). Therefore, the FBOUT terminal of the control circuit unit Z2 is substantially connected to only the capacitor C4. Here, if the output overvoltage due to the load opening has occurred, the Zener diode ZD1 is conducted by the voltage increase of the Vcc terminal, and the switching element M3 is turned off due to the output of the inverting circuit INV1. Since the voltage of FBOUT terminal rises rapidly and is pulled up due to turning-off of the switching element M3 and the discharge current of FBOUT terminal, the output of the comparator CP5 is turned off and the switching operation of the switching element M1 is stopped. That is, the operating voltage of the OVP circuit due to the load opening can be set arbitrarily by the Zener voltage of the Zener diode ZD1 which is an external element of the control circuit unit Z2.

Further, the operation speed until the output of the comparator CP5 is turned off from the voltage rise of the Vcc terminal is fast since it does not require charging of the capacitor, it is rapidly enabling to perform the protection operation when the load is opened. Therefore, since it is possible to suppress an increase of the output voltage at the time of the load opening and thereby there is no need to provide an excessive margin of capacitance of the smoothing capacitor C1, it is possible to design a minimum withstand voltage and decrease the cost of the power supply.

Incidentally, in the background circuit (LED lighting device 1) shown in FIG. 21 and FIG. 22, since the comparator CP3 within the control circuit unit Z1 is made to function as the OVP circuit, the operating voltage cannot be set arbitrarily. In addition, even if the other terminals of the control circuit unit Z1 are made to have the OVP function, there may be a case where the protective operating speed is slow in actual operation, and a sufficient performance is not obtained. The reason is that a capacitor for controlling a stable operation is connected to each terminal, so that it takes a constant time in the changing and the instantaneous protection operation is difficult.

As described above, according to the first illustrative embodiment, the LED lighting device 10 converts the AC input voltage Vin as rectified to a DC voltage to thereby supply it to the LED load RL, by performing on-and-off control of the switching element M1 which is connected in series to the reactor L1. The LED lighting device 10 is provided with the control circuit (comparator CP1) which operates in a floating state with respect to an after-rectified ground line GND1 and controls the on-width of the switching element M1 based on the current flowing in the LED load RL and reactor L1, and the oscillation circuit OSC1 which controls the switching frequency of the on-and-off control by the control circuit (comparator CP1), asynchronously with the energy release timing of the reactor L1. According to this configuration, it is possible to perform the switching operation that is different from the critical mode and it enables the input current waveform to be close to a sine-wave, thereby easily achieving the harmonic current regulation. Since this effect can be obtained even in the case where the AC input voltage Vin is at a high voltage or a light load, it is possible to fully achieve the harmonic current regulation even in a dimming operation (light load) that is also a feature of the LED illumination.

Further, according to the first illustrative embodiment, the switching frequency is controlled to be constant by the oscillation circuit OSC1. According to this configuration, it is possible that the AC input voltage Vin serves to suppress the switching current average of the period in the vicinity of the 0 (V) and enables the input current waveform to be closer to a sine-wave form.

Further, in the critical mode in which the switching frequency is not fixed in the background art, in the dimming operation (light load), the smaller the load current becomes, the more the switching frequency is increased. Accordingly, the power supply cannot be completely lowered, and it is impossible to perform the dimming to be performed up to the lights-out region. In contrast, due to constantly controlling the switching frequency, the dimming from light to dark is to be possible.

Further, according to the first illustrative embodiment, the LED lighting device 10 converts the AC input voltage Vin as rectified to a DC voltage and supply it to the LED load RL, by performing on-and-off control of the switching element M1 that is connected in series to the reactor L1. The LED lighting device 10 is provided with the control circuit (comparator CP1) which operates in a floating state with respect to an after-rectified ground line GND1 and controls the on-width of the switching element M1 based on the value, as a feedback signal, of the current flowing in the LED load RL and reactor L1, the voltage rise detecting circuit (Zener diode ZD1, inverting circuit INV1, switching element M3) that detects an increase of the output voltage and performs the pull-up of the feedback signal, and the overvoltage protection circuit (comparator CP5) that stops the on-and-off control of the switching element M1 by the pull-up of the feedback signal. According to this configuration, it is possible to set the overvoltage protection operation as the optimum voltage, and it is possible to be operated at high speed. Therefore, it is possible to reduce the breakdown voltage of the components connected to the LED load (RL) side to the limitation thereof, and it is possible to reduce the cost of the overall power supply by the miniaturization of components used and the reduction of the substrate area, or the like.

### Second Illustrative Embodiment

The LED lighting device 20 of the DC power supply device according to the second illustrative embodiment of this disclosure is configured to lower the oscillation frequency thereby limiting the switching current during a rising time of the AC input voltage Vin. It is possible to cause the wave input current waveform Iin to approximate a sine-wave by the LED lighting device 20 according to the first illustrative embodiment. However, the input current waveform Iin is in a state where the phase thereof is advanced than that of the AC input voltage Vin. This tendency, as shown in FIG. 5A or 7A, becomes more apparent as the voltage of the AC input voltage Vin increases. Therefore, the LED lighting device 20 according to the second illustrative embodiment serves to limit the switching current during the rising time of the AC input voltage Vin, thereby allowing the input current Iin to be closer to a sine-wave to further suppress the harmonic current.

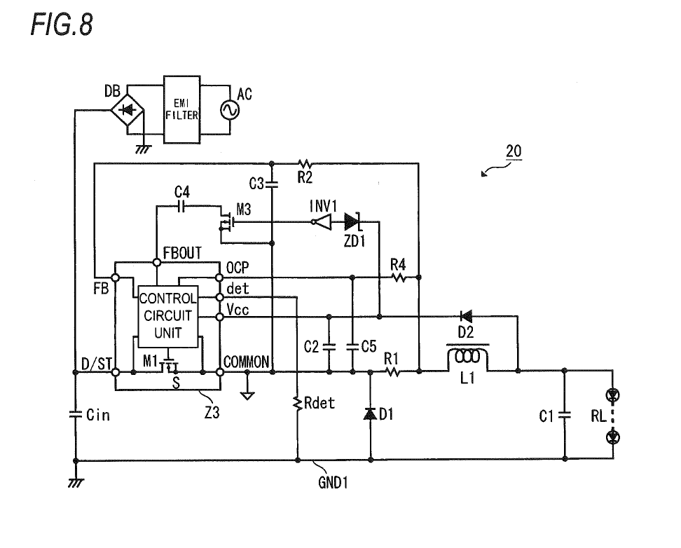

As shown in FIG. 8, in the LED lighting device 20, instead of the control circuit unit Z2 of the first illustrative embodiment 1, the control circuit unit Z3 provided with a det terminal is connected to the positive terminal of the rectification output (positive terminal of the capacitor Cin) of the rectifier circuit DB, in a state where the COMMON terminal is floated. The det terminal of the control circuit unit Z3 is a terminal for detecting the vicinity of the 0 (V) of the AC input voltage Vin and is connected to the negative terminal of the rectification output (negative terminal of the capacitor Cin) of the rectifier circuit DB via the resistor Rdet.

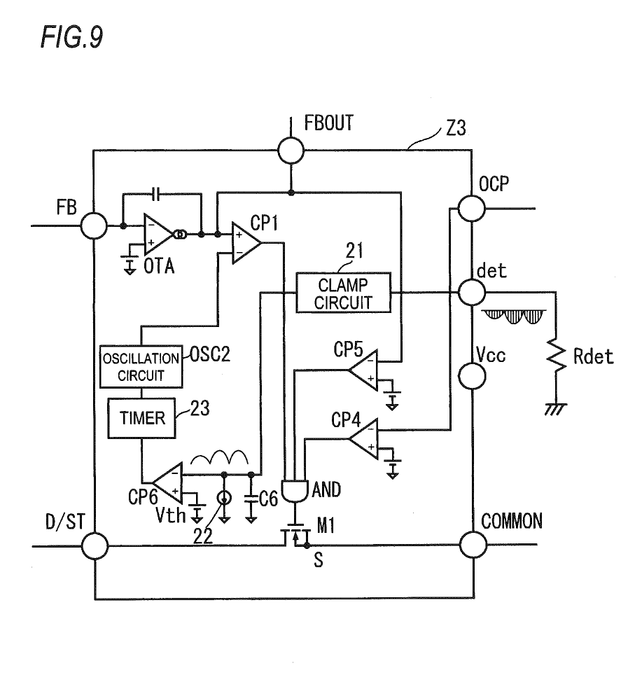

As shown in FIG. 9, in addition to the configuration of the control circuit unit Z2 of the first illustrative embodiment, the control circuit unit Z3 is provided with a clamp circuit 21, a capacitor C6, a constant current source 22, a comparator CP6, a timer circuit 23, and an oscillation circuit OSC2 having a frequency switching function.

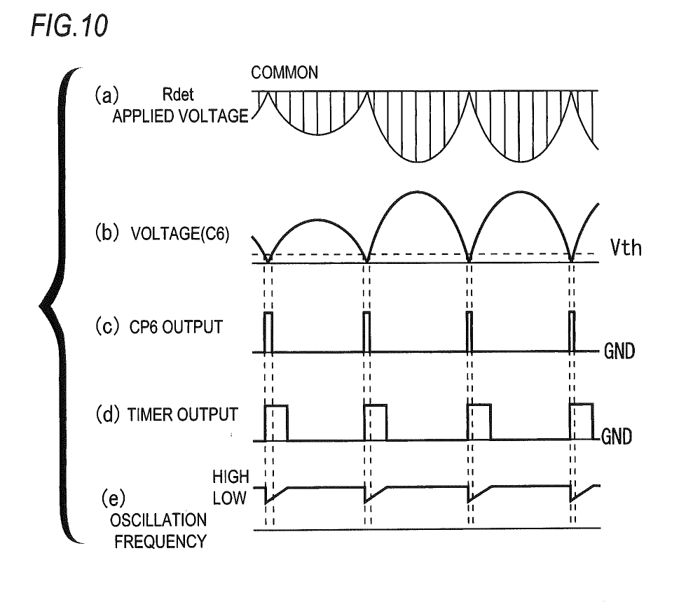

Since the COMMON terminal and the negative terminal of the rectification output(negative terminal of the capacitor Cin) of the rectifier circuit DB are not in a common potential, a resistance-potential division type input is impossible. Therefore, on assuming that the control circuit unit Z3 has been switched to a negative voltage relative to a voltage of the COMMON terminal, the voltage applied to the resistor Rdet shown in a waveform (a) of FIG. 10 is converted in voltage-current conversion and is input to the det terminal.

An input terminal of the clamping circuit 21 is connected to the det terminal. The clamp circuit 21 has a function to clamp a negative potential and also a function of a current mirror circuit. As shown in a waveform (b) of FIG. 10, the output of the clamping circuit 21 is generated in a voltage waveform similar to a full-wave rectification waveform of the AC input voltage Vin by the constant current source 22 and capacitor C6 and is input to an inverting input terminal of the comparator CP6.

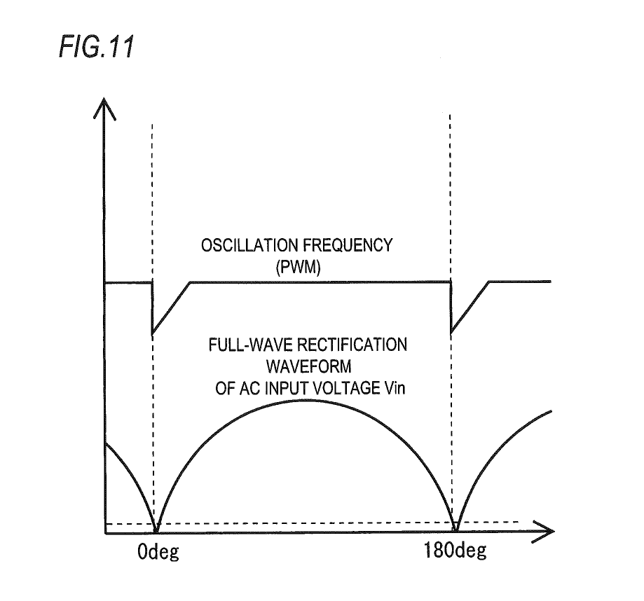

A reference voltage Vth is input to a non-inverting input terminal of the comparator CP6. As shown in a waveform (c) of FIG. 10, if a voltage waveform similar to the full-wave rectification waveform of the AC input voltage Vin falls below the reference voltage Vth, the output of the comparator CP6 becomes a Hi level and the vicinity of 0 (V) of the AC input voltage Vin is detected. As shown in a waveform (d) of FIG. 10, if the output of the comparator CP6 is at a Hi level, the timer circuit 23 outputs a signal having a High level for a predetermined time (for example, 2 ms) set in advance. The oscillation circuit OSC2 has a frequency control function, and lowers the oscillation frequency, as shown in waveform (e) of FIGS. 10 and 11, while the output of the timer circuit 23 is at the High level. As a result, the period (off period) during which the comparator CP1 is at a Low level is extended, and the switching current is limited. FIG. 11 illustrates an example, in which the oscillation frequency is decreased as the output of the timer circuit 23 increases and reverted gradually. However, the reverting method or the decrease width of the oscillation frequency may be appropriately set depending on the element characteristics.

As described above, according to the second illustrative embodiment, the predetermined time during which the AC input voltage Vin increases is configured to decrease the switching frequency by the oscillator OSC2. According to this configuration, the switching current is limited during the rise period of the AC input voltage Vin, so that it is possible for the input current Iin to further approximate a sine-wave, thereby suppressing the harmonic current.

### Third Illustrative Embodiment

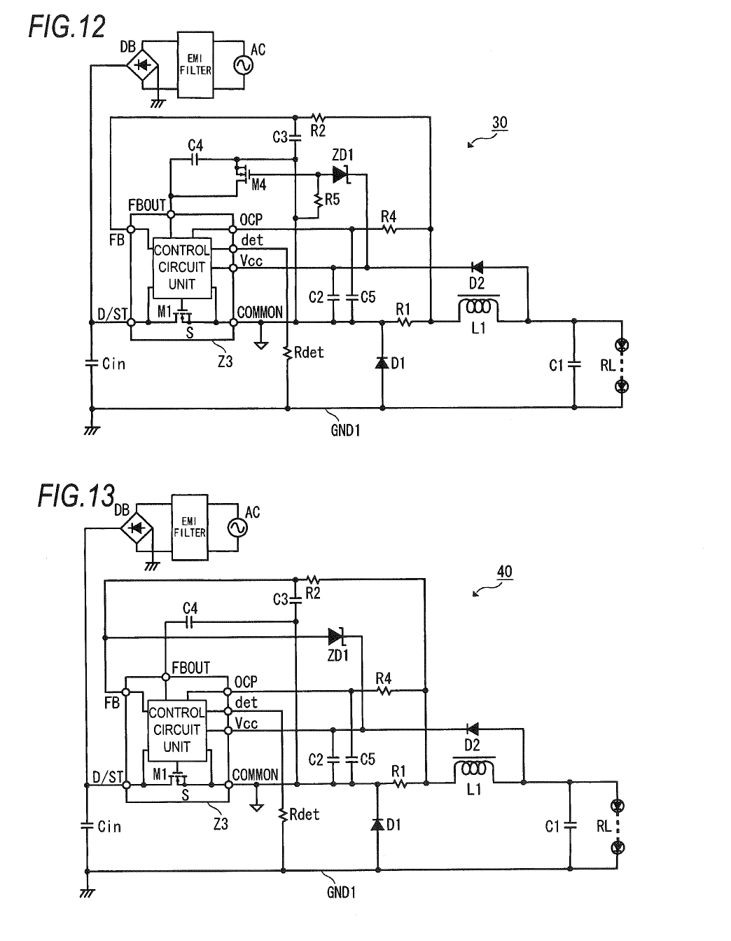

In the LED lighting device 30 of the DC power-supply apparatus according to the third illustrative embodiment of this disclosure, as shown in FIG. 12, a switch element M4 of a small-signal MOSFET or the like is connected in parallel to the capacitor C4 that is connected to the FBOUT terminal of the control circuit unit Z3. The Vcc terminal of the control circuit unit Z3 and the cathode of the Zener diode ZD1 are connected to each other, and the anode of the Zener diode ZD1 is connected to the gate of the switching device M4. Further, the resistor 5 is connected between the anode of the Zener diode ZD1 and the COMMON terminal.

The switching element M4 is in an off-state in a normal time (when the voltage of the Vcc terminal is below the Zener voltage of the Zener diode ZD1). Therefore, the FBOUT terminal of the control circuit unit Z3 is connected to only the capacitor C4 substantially. At this time, when the output overvoltage due to the load opening occurs, the Zener diode ZD1 is conducted by the voltage rise of the Vcc terminal, and the switching element M3 is turned on. According to turning-on of the switching element M3, the COMMON terminal and the FBOUT terminal are connected to each other, and the FBOUT terminal is pulled down. Thus, it functions as an on-off circuit (start-up and stop circuit of the control circuit unit Z3) and the switching operation of the switching element M1 is stopped.

As described above, according to the third illustrative embodiment, the LED lighting device 30 converts an AC input voltage Vin rectified to a DC voltage to supply it to the LED load RL by on-and-off control of the switching elements M1 that is connected in series to the reactor L1. The LED lighting device 30 is provided with a control circuit (comparator CP1) that operates in floating state with respect to the ground line GND1 rectified and controls the on-width of the switching element M1 based on the current value, as a feedback signal, flowing in the reactor L1 and the LED load RL, the voltage rise detecting circuit (Zener diode ZD1, switching element M4) that pulls down the feedback signal by detecting the increase of the output voltage, and the overvoltage protection circuit (comparator CP1) that stops the on-and-off control of the switching element M1 by the pull-up of the feedback signal. According to this configuration, the overvoltage protection operation can be set as an optimum voltage value. Further, the control circuit (comparator CP1) for controlling an on-width can be used as the overvoltage protection circuit, accordingly, there is no need to provide a separate circuit for overvoltage protection within the control circuit unit Z3.

### Fourth Illustrative Embodiment

In the LED lighting device 40 of the DC power-supply apparatus according to the fourth illustrative embodiment of this disclosure, as shown in FIG. 13, the cathode of the Zener diode ZD1 and the Vcc terminal of the control circuit unit Z3 are connected to each other, the anode of the Zener diode ZD1 is connected to the FB terminal of the control circuit unit Z3. The Zener diode ZD1 is conducted by the voltage rise of the Vcc terminal, and the FB terminal is pulled up. Further, by providing the threshold of positive side to the transconductance amplifier OTA of the control circuit unit Z3, the pull-up of the FB terminal is detected, and the switching operation of the switching element M1 is stopped.

As described above, according to the fourth illustrative embodiment, the LED lighting device 40 for converting an AC input voltage Vin rectified to a DC voltage to supply it to the LED load RL by on-and-off control of the switching elements M1 that is connected in series to the reactor L1, the LED lighting device 40 is provided with the control circuit (comparator CP1) that operates in floating state with respect to the ground line GND1 rectified and controls the on-width of the switching element M1 based on the current value, as a feedback signal, flowing in the reactor L1 and the LED load RL, the voltage rise detecting circuit (Zener diode ZD1) that pulls down the feedback signal by detecting the increase of the output voltage, and the overvoltage protection circuit, which may be replaced with the transconductance amplifier OTA, that stops the on-and-off control of the switching element M1 by the pull-up of the feedback signal. According to this configuration, the overvoltage protection operation can be set as an optimum voltage value. Further, the transconductance amplifier OTA generating a feedback signal can be used as the overvoltage protection circuit, so that there is no need to provide a separate circuit for overvoltage protection within the control circuit unit Z3.

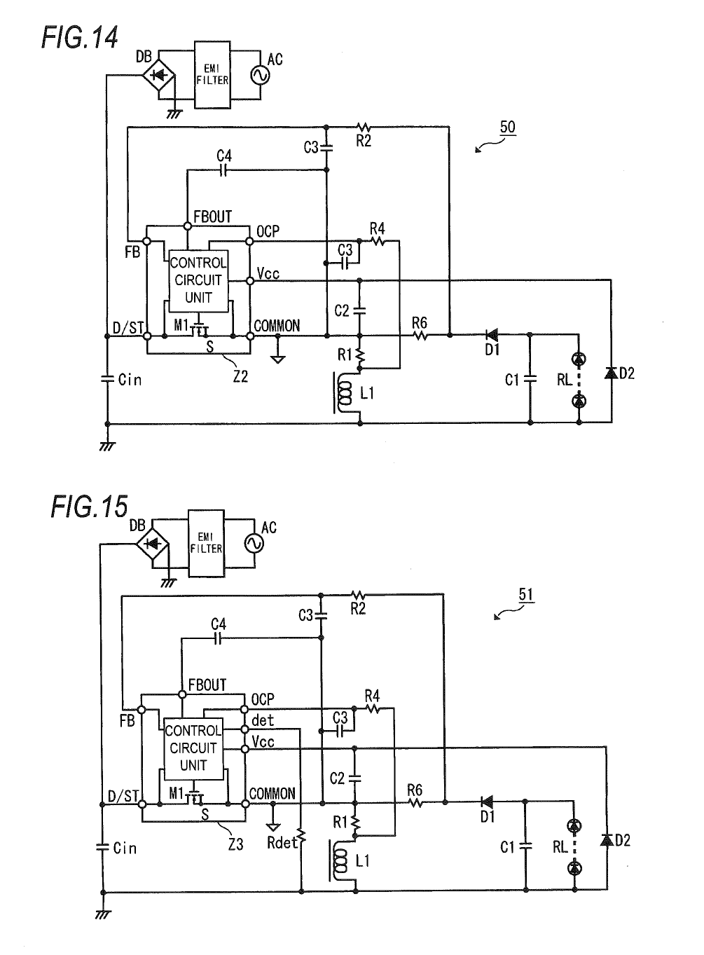

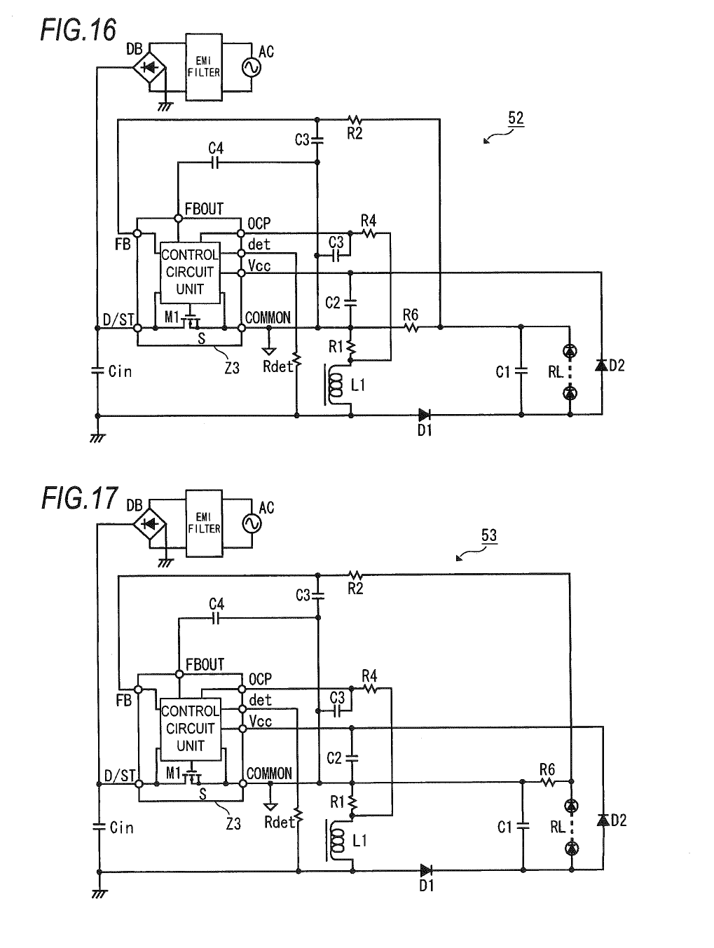

In the first to fourth illustrative embodiments, although the buck chopper (step-down chopper) circuit is described as an example, as shown in FIGS. 14 to 17, this disclosure may also be applied to a buck-boost circuit (step down and up chopper). FIG. 14 illustrates the LED lighting device 50 in which the first illustrative embodiment is applied to a buck-boost circuit, and FIGS. 15 to 17 show the LED lighting devices 51, 52, 53 in which the second illustrative embodiment is applied to various buck-boost circuits, respectively.

Further, when adopting the buck-boost circuit, it is possible to suppress the micro emission of the LED load RL. That is, in the LED lighting device that is turned on-and-off by external ON/OFF signals, it is preferable that the LED lighting device is completely turned off (no light emission) in a lights-out state. However, since the LED load RL used in a light-emitting part is an element capable of emitting light even by a very small amount of current, if a small amount of leakage current of the control circuits Z2, Z3 flows to the LED, there is a case where the micro emission appears even though it is in the lights-out state by an OFF-signal.

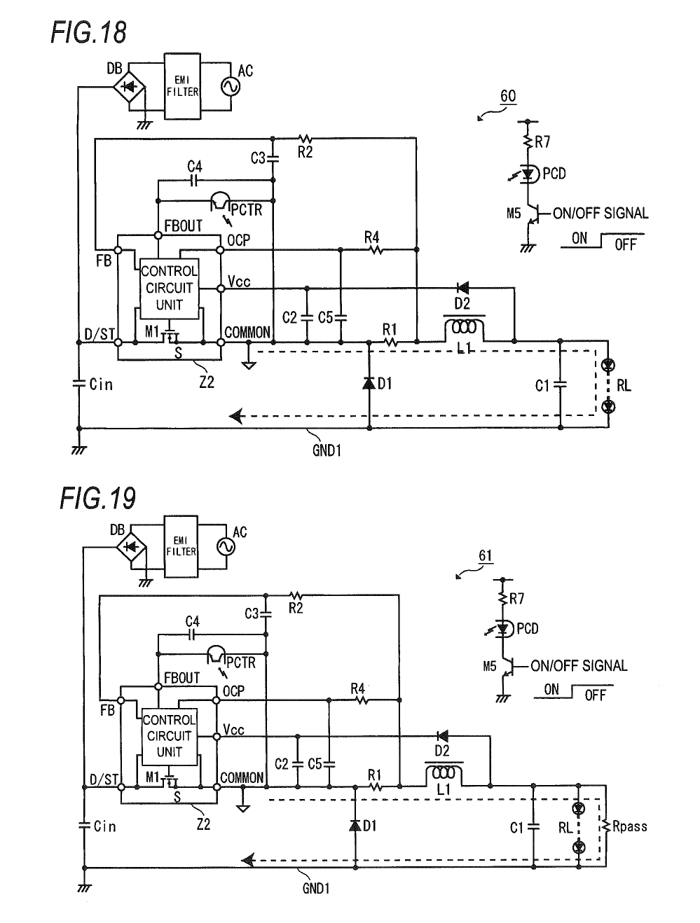

For example, in the LED lighting device 60 that employs a buck chopper circuit as shown in FIG. 18, a parallel circuit configured by a capacitor C4 and a light receiving element PCTR of a photo coupler is connected between the COMMON terminal and the FBOUT terminal of the control circuit unit Z2. In addition, the switching element M5, which is controlled by the ON/OFF signal, is connected in series to the light emitting element PCD of a photo-coupler. Thus, at the lighting time by the ON-signal, the light receiving element of the photo-coupler PCTR is conducted, and the FBOUT terminal is connected to only the capacitor C4 substantially. Incidentally, at the lights-out time by the OFF-signal, the light-receiving element PCTR of the photo-coupler is conducted, the FBOUT and COMMON terminals are connected to each other, and the FBOUT terminal is pulled down. Thus, it functions as an on/off circuit (start/stop circuit) of the control circuit unit Z2, and the switching operation of the switching element M1 is stopped.

However, in the control circuit unit Z2, as long as power is supplied to the Vcc terminal, the control circuit current is always flowing, and the control circuit current (about 1 mA) is flowing as leakage current from the common terminal. Therefore, even though the switching operation is stopped by the OFF-signal, since a leakage current passes through the loop designated by the dotted arrow line in FIG. 18 from the control circuit unit Z2, the LED load RL results in micro emission. Therefore, it is lit dimly even in the lights-out.

Meanwhile, as in the LED lighting device 61 employing a buck chopper circuit shown in FIG. 19, by connecting the resistor Rpass in parallel to the LED load RL, the leakage current from the control circuit unit Z2 flows through the resistor Rpass as indicated by the dotted arrow line in FIG. 19, and thereby it is possible to absorb the leakage current at the lights-out time by the resistor Rpass. However, the resistor Rpass works as a load even at the time of turning-on and cause a decrease in efficiency as the amount of current flowing therein increases.

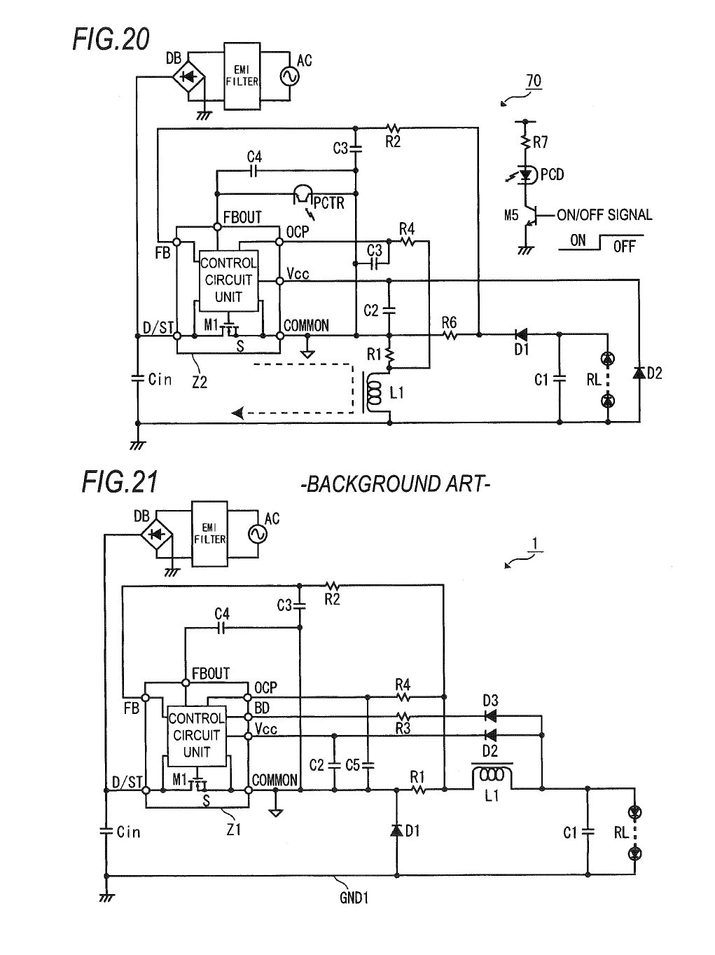

In contrast, by adopting the buck-boost circuit as shown in FIG. 20 as the LED lighting device 70, it is possible to suppress the micro emission of the LED load RL even if there is leakage current from the control circuit unit Z2. That is, in the buck-boost circuit, as designated shown by the dotted arrow line in FIG. 20, the leakage current flowing from the common terminal is blocked in the regenerative diode D1 connected in series with the LED load RL and flows into the reactor L1. Therefore, the LED load RL does not emit micro light due to a leakage current. Therefore, it is possible to suppress the micro emission of LED without adding a leak path resistance causing a decrease in efficiency.

As described above, in the LED lighting apparatus, by employing the floating buck-boost chopper, the path of a leakage current from the control circuit unit Z2 is formed at the lights-out time, so that it is possible to cause the LED load RL to be in a non-light emission state completely.

This disclosure has been described according to the specific illustrative embodiments. However, the above-described illustrative embodiments have been just described as an example. However, it goes without saying that changes may be made in these illustrative embodiments without departing from the spirit and scope of this disclosure.

What is claimed is:

1. A DC power-supply apparatus of converting an AC input voltage rectified to a DC voltage and supplying it to a load, by performing on-and-off control of a switching element connected in series to a reactor, comprising:
a control circuit, which operates in floating state with respect to a after-rectified ground line and controls an on-width of the switching element based on a value of current flowing through the reactor and the load connected in series with the reactor; and
an oscillation circuit, which controls a switching frequency of the on-and-off control by the control circuit, asynchronously with energy release timing of the reactor.

2. The DC power-supply apparatus according to claim 1,
wherein the oscillation circuit controls the switching frequency to be constant.

3. The DC power-supply apparatus according to claim 2,
wherein the oscillation circuit lowers the switching frequency during a predetermined rising time of the rectified AC input voltage.

4. The DC power-supply apparatus according to claim 1,
wherein the load is an LED, and
wherein the control circuit performs a constant current control so that values of current flowing in the reactor and the load are constant.

5. A DC power-supply apparatus of converting an AC input voltage rectified to a DC voltage and supplying it to a load, by performing on-and-off controlling of a switching element connected in series to a reactor, comprising:
a control circuit, which operates in floating state with respect to a after-rectified ground line and controls an on-width of the switching element based on a value, as a feedback signal, of current flowing through the reactor and the load connected in series with the reactor;
a voltage rise detecting circuit, which detects an increase of an output voltage and performs pull-up or pull-down of the feedback signal; and
an overvoltage protection circuit, which stops the on-and-off control of the switching element by the pull-up or pull-down of the feedback signal.
